(19) United States
(12) Patent Application Publication
(10) Pub. No.: US 2015/0087339 A1
(43) Pub. Date: Mar. 26, 2015

(54) Wireless Location Information Request

(71) Applicant: Todd Alan Kuhlmann, Austin, TX (US)

(72) Inventor: Todd Alan Kuhlmann, Austin, TX (US)

(21) Appl. No.: 14/033,475

(22) Filed: Sep. 22, 2013

(51) Int. Cl. H04W 4/02; H04W 64/00

(52) U.S. Cl. CPC H04W 4/02; H04W 64/00
USPC 455/456.2

(57) ABSTRACT

A system and method for wireless location specific information request and retrieval using a communication network comprising: a wireless user display device communicating over the network with a server and the server communicating with a location information database or directly interacting with the third party representative associated with the property, business, landmark, product, event or object of user's interest. The method includes capturing image of the property, business, landmark, product, event or object of user's interest or manually inputting the information request regarding property, business, landmark, product, event or object of user's interest using the wireless user display device along with the geographic location of the property, business, landmark, product, event or object of user's interest and then requesting the either the associated third party representative or the server for the related information. The server then communicates with the property, business, landmark, product, and event or object database and request for the associated information. The property, business, landmark, product, event or object database extracts the requested information and transmits the generated report back to server which further processes the received information for generating wireless user display device ready report format which further enables the user to save, edit and share the generated information over the wireless communication network with other users.

### FIELD OF THE INVENTION

The present invention relates generally to a wireless location specific information retrieval method and system, and more particularly, to a location retrieval system using a wireless communication device.

### BACKGROUND OF THE INVENTION

Wireless communication devices have revolutionized the communication between two devices and associated users and the use of such wireless devices has also increased rapidly in the recent years. The primary mode of information sharing and requesting in the recent past was voice based or text based communication between two parties which further depend upon the intelligence of the two parties involved in the communication, wherein one party's limited knowledge can lead to incomplete information which can be one of the reasons to lose relevant business opportunities. For example, in the current real estate industry where clients prefer to physically visit the property rather than reading, reviewing and commenting online such kind of wireless communication can be of great utility to connect buyers with the right third party property representatives.

In some of the cases the third party representative contact information is provided at the location, property, business, landmark, product, event or object location and the buyer or user interested in a particular location can easily contact the third party representative. However, most of the times the buyers or users prefer to contact the third party representative after reviewing their credentials or selecting out of a list of representatives to find the best match for their expectations which is not possible in most of the cases. Another disadvantage of the traditional location, property, business, landmark, product, event or object information sharing system is that the selections of the representative is inefficient and also time consuming where the buyer or user has to make all the efforts for reaching the property representative.

Another disadvantage with current information sharing system is that sometimes the location, property, business, landmark, product, event or object doesn't have any contact information associated with it and if the user wants to know about the location they cannot find the contact details or the right representative for the same.

For instance, U.S. Pat. No. 6,385,541 outlines a method disclosing a database with real estate information communicating with the user via a wireless connection.

For instance, U.S. Pat. No. 6,496,776 outlines a method disclosing retrieval of information from a database based on a geographic position and transmitting the information to be received through a wireless device.

For instance, U.S. Pat. No. 7,072,665 outlines a method disclosing retrieval of information and display of the information on wireless devices based on the geographic position.

For instance, U.S. Pat. No. 7,599,795 outlines a method disclosing identification of a geographic position on a wireless device and data input by a user while user is at the geographic position. The data is then associated with a landmark at the geographic position of the wireless device and the receiver is configured to automatically provide information to the user associated with the landmark from the database.

A disadvantage with the above mentioned solutions is that the user either has to select a geographic location or the user has to type in the name of the property, landmark, business, product, event or object for searching and extracting the relevant information regarding a place or location of interest which is sometimes not available and the user has to search on multiple databases for the same. Another disadvantage of the traditional information search and retrieval system is that the user has to search separately for the location information and then for the associated third party representative on different databases. Another disadvantage of the above mentioned traditional solutions is that the information provided to the user is limited to the data available in the predetermined databases without human interaction from a third party representative which is necessary in most cases to ensure the user receives updated information and human suggestions as requested about the location, property, business, landmark, product, event or object of user's interest.

Thus there is a need of a system and method that enables the user to request accurate location information easily, quickly and efficiently. There is a need of a system and method that can link the requested image based location information, or photo geotagging, with the third party representative information. There is a need of a system and method for third party representatives to obtain business from a new or existing user.

### SUMMARY OF THE INVENTION

To solve the problems described above, the present invention provides following solutions.

In a preferred embodiment of the present invention there is provided a system and method for wireless location information request for receiving information request from a wireless communication device through a wireless communication network, wherein the received information request includes image of the property, business, landmark, product, event or object, name or location selected or inputted through the wireless communication device. The system and method of the present invention request for the additional information of a buyer or a user of the wireless communication device which is preferably provided by the user through the wireless communication device by filling an information request form or submitting a video/audio message. In another method, the additional information is extracted from the user's communication device by using the wireless communication network. The user can further forward a request to a third party representative to be associated with the property, business, landmark, product, event or object for providing requested additional information by selecting the preferred representative through the wireless communication device.

In another embodiment of the present invention there is provided a system and method for a wireless location information request, directed to transmit the user information request using a wireless communication device through a webservice request, such as but not limited to, JSON, XML, email or HTML created by the user display device comprising a user access verification data to validate user's access to a server and a location specific information. In a method of the present invention, the information request is transmitted to a third party representative's electronic device for further processing. In another method the server then request a database for additional information, such as but not limited to, location, property, business, landmark, product, event or object which can further communicate with the other associated databases containing the location information specific to the buyer or user's request. The database extracts the requested additional information and submits the same to the server. The server then starts processing the received additional information from the database and converts the received information in the form of a report and submits the report to third party representative as selected by the user.

In another embodiment of the present invention, the wireless information request is received in the form of an image clicked from the built-in camera of the wireless communication device. The image includes photo geotagging, providing the location information of where the user captured the image.

In a further embodiment of the present invention, the user location is determined by using a global positioning system or the triangulated position of the user's display device.

In a preferred embodiment of the present invention, the additional information database includes databases, such as but not limited to, third party information databases, geographic information systems (GIS), state or local agencies, local property administration and national government databases that have been created and compiled by other sources, such as but not limited to, the third party location advisors, geographic information systems, elements, property, imagery, state and local agencies.

In another embodiment of the present invention, the server converts received location specific additional information such as but not limited to, location, property, business, landmark, product, event or object into an electronic readable format by the third party representative's display device.

In another embodiment of the present invention, the user display device presents the transmitted information in an easy to read format, such as but not limited to, images, property layout, room images, property price, landmarks, pricing graphs as offered by different third party property advisors or the like.

In further embodiment of the present invention, the user can share, print, upload or email the presented additional property location specific information to other users using the wireless communication network.

Further features and advantages of the present invention, as well as the structure and operation of various embodiments of the present invention, are described in detail below with reference to the accompanying drawings.

### BRIEF DESCRIPTION OF THE DRAWINGS

For the purpose of illustration, there are shown in the drawings certain embodiments of the present invention wherein like reference numbers generally indicate identical, functionally similar, and/or structurally similar elements. It should be understood that the invention is not limited to the precise arrangements, dimensions, and instruments shown.

FIG. 1 depicts a wireless location specific information request system according to an exemplary embodiment of the present invention;

FIG. 2 depicts a method of wireless location specific information request and reporting system according to an exemplary embodiment of the present invention;

FIG. 3a depicts an exemplary embodiment of using a wireless user display device for capturing an image in accordance with the embodiments of the present invention;

FIG. 3b depicts a built-in camera of the wireless user display device;

FIG. 3c depicts an exemplary user form for requesting additional information from the user; and

FIG. 4 depicts an exemplary embodiment of a user display device illustrating wireless location specific information report according to an exemplary embodiment of the present invention.

### DETAILED DESCRIPTION OF THE INVENTION

In this section, some preferred embodiments of the present invention are described in detail sufficient for one skilled in the art to practice the present invention. It is to be understood, however, that the fact that a limited number of preferred embodiments are described herein does not in any way limit the scope of the present invention as set forth in the appended claims. It is also to be understood that a person skilled in the relevant art will recognize that other components and configurations can be used without parting from the spirit and scope of the invention.

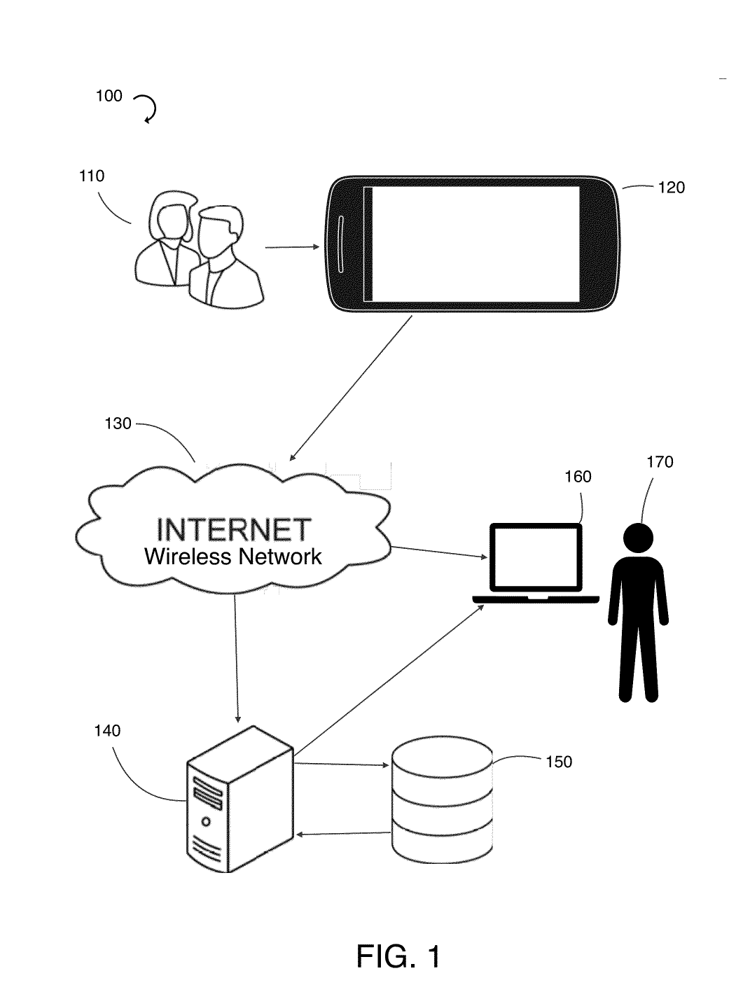

Referring to FIG. 1, there is shown a wireless location information request system 100 comprising a user 110 and a wireless user display device 120, such as but not limited to, smartphone, personal digital assistance, palmtop or laptop. The wireless user display device 120 further comprises a global positioning system or the triangulated position determination means for determining and communicating the user's location. The wireless user display device 120 is using a wireless communication network 130 for transmitting and receiving information from a server 140 located at a secure location. The server 140 is further transmitting and receiving information from a location information database 150, such as but not limited to, third party information databases, geographic information systems (GIS), state or local agencies, local property administration and national government databases which are already maintained for location specific information retrieval and presentation such as but not limited to, location, property, business, landmark, product, event or object. The server 140 and the location information database 150 are further connected to a third party property representative's electronic display device 160, such as but not limited to, smartphone, personal digital assistance, palmtop, laptop or desktop of a third party representative 170. In an exemplary embodiment of the present invention the wireless user display device 120 uses the wireless communication network 130 to transmit the location information request directly to third party representative's electronic display device 160 and associated third party representative 170.

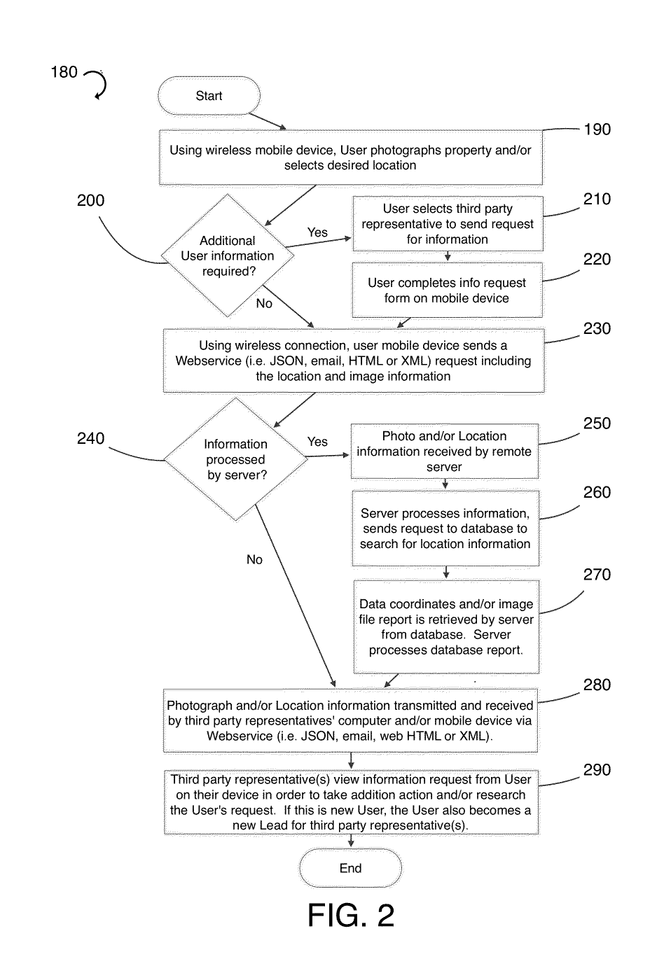

Referring to FIG. 2, there is shown a method for property location information reporting 180 in operation. At block 190, the user 110 selects a desired location either by capturing image of the desired property, which further includes the photo geotagging, using the current location of the wireless user display device or by inputting manually the property location on the wireless user display device 120. At block 200, the wireless location information system 100 further review the available information and if the additional information is required, the wireless location information system 100 requests the user 110 for providing additional information with respect to submitted request at block 190. At block 210, the user 110 selects an option on the wireless user display device 120 and selects the third party representative 170 to submit a request for the additional information. At block 220, the user 110 completes information request and further submits through wireless user display device 120. At block 200, if no additional information is required, the wireless location information system 100 directly moves to block 230. At block 230, the location specific information request is submitted through a wireless user display device 120 in the form of a webservice, such as but not limited to, JSON, email, XML or HTML. At block 240, in one method, the server 140 accepts the information request and starts processing the received request at block 250 in the form of property image, location name or location coordinates. At block 260, the server submits the processed information request to location information database 150. At block 270, the location information database 150 submits the extracted information to the server 140 which further retrieves the data coordinates or image reports and starts processing the information received from the location information database 150. At block 240, in another method of the present invention, the information request is not processed by the server 140 and the wireless location information system 100 directly submits the location information request submitted through the wireless user display device 120. At block 280, the wireless location information system 100 submits the image and/or location request information such as but not limited to, the geographic information systems, elements, property, imagery, state and local agency information to the third party representative's electronic display device 160. At block 290, the third party representative 170 accesses the received information on the third party representative's electronic display device 160 for further processing and/or research and then for contacting the user 110 with requested information.

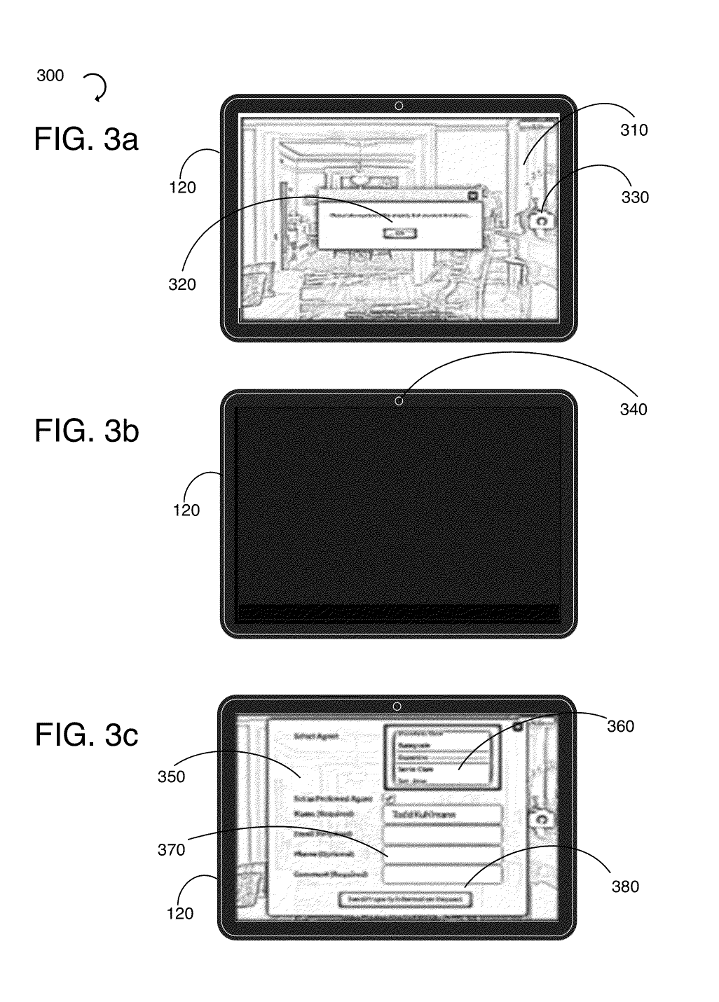

Referring to FIG. 3a, there is shown a preferred embodiment 300 of the present invention comprising the wireless user display device 120, such as but not limited to, smartphone, smartwatch, wristphone, PDA or tablet. Referring to FIG. 3b, the wireless user display device 120 includes a built-in camera 340. Referring back to FIG. 3a, the user 110 selects the camera icon 330 on the wireless user display device 120 for capturing a property image 310 by clicking the camera icon 330 on the user interface of the wireless user display device 120, which activates the built-in camera 340 of the wireless user display device 120. The user 110 can also select the property location using GPS system or the triangulated position of the wireless user display device 120 or by inputting the property name and/or location through the user interface of the wireless user display device 120. The wireless user display device 120 further displays an instructional message 320 before submitting the information request.

Referring to FIG. 3c, there is shown another embodiment of the present invention. The wireless user display device 120 displays a user form 350 for requesting additional information from the user 110. The user form 350 provides a third party representative selection option 360 for requesting third party representative 170 for generating the additional information for the user 110. In another method, the user 110 input the additional information in an additional information section 370. The user 110 then submits the selection by clicking on a submit button 380.

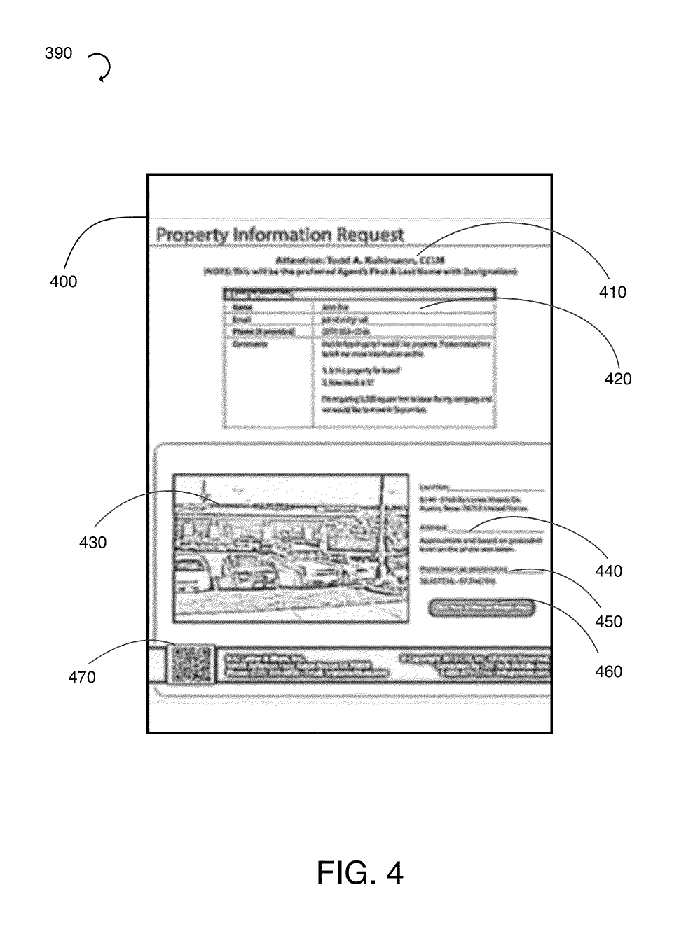

FIG. 4 shows another preferred embodiment of the present invention for displaying the generated location specific information report 390 in the wireless user display device 120 readable format, such as but not limited to, JSON, email, XML or HTML. The location specific information report 390 includes a name section 400 of the third party representative selected by the user 110, a manually inputted information section 410, a location, property, business, landmark, product, event or object image display section 420, a latitude and longitude coordinates display section 430 as provided by the User wireless display device 120 for the location of the user 110 interest, a location physical address display section 440 as extracted by the location information database 150 and presented by the server 140, a button 450 for selecting a street or satellite view of the location of the user 110 interest and an additional branding section 460 for presenting additional branding information of the user and/or third party representative 170, such as but not limited to, QR codes or the like.

In a preferred embodiment of the present invention, the location information request from the wireless user display device 120 comprising buyer and/or user 110 information may also be electronically added to a business information database running on the third party representative electronic display device 160, such as but not limited to, lead generation, CRM (customer relationship management), or other database to track inbound information requests and/or contact information.

Although the present invention has been described in detail with reference to certain examples thereof, it may be also embodied in other specific forms without departing from the essential spirit or attributes thereof.

In addition, some embodiments of the present invention may be integrated with an information website or video broadcast system. That is, many location, property, business, landmark, product, event or object information websites already utilize a plurality of cameras and camera operators to provide live video broadcasts and property related information live display. These systems are designed to capture unpredictable live changes in the location, property, business, landmark, product, event or object information, such as but not limited to, availability and price of the property or item. The present invention can take advantage of this pre-existing information databases and can avoid labor investment to provide information to the user 110.

The present invention and components thereof are also capable of being distributed as a program product in a variety of forms, and applies equally regardless of the particular type of user display device being used to actually carry out the wireless location information request.

The accompanying figures and this description depicted and described embodiments of the present invention, and features and components thereof. Accordingly, it is desired that the embodiments described herein be considered in all respects as illustrative, not restrictive, and that reference be made to the appended claims for determining the scope of the invention.

We claim:

1. A method for wireless location specific information request and retrieval, the method comprising:
entering a location information request through a wireless user display device;
transmitting the entered location information request to a server using a wireless communication network;
receiving the entered location information request along with the associated geographical coordinates by the server;
providing associated location representative information to the user for selecting preferred property representative;
submitting the received location information request and associated information to a third party representative,
wherein the third party property representative further processes the requested property information and share the extracted location information with the user in a report format as per the received user related contact information.

2. The method of claim 1, wherein said location is a location of the property, business, landmark, product, event or object.

3. The method of claim 1, wherein said location information request is an image of the property, business, landmark, product, and event or object that may contain the photo geotag for location identification.

4. The method of claim 1, wherein said location is determined by a global positioning system or the triangulated position of the user's display device.

5. The method of claim 1, wherein said selection of desired location on the wireless user display device includes location input by using the wireless user display device keypad.

6. The method of claim 1, wherein said wireless user display device is a smartphone, personal digital assistance, wristphone, palmtop or laptop.

7. The method of claim 1, wherein said location information database is a third party information databases, geographic information systems (GIS), state or local agencies, local property administration and national government databases.

8. The method of claim 1, wherein said third party property representative's electronic display device is a smartphone, personal digital assistance, palmtop, laptop, desktop or other electronic display device.

9. The method of claim 1, wherein said webservice request is JSON, email, XML or HTML.

10. The method of claim 1, wherein said transmitted report is created in the JSON, email, XML or HTML.

11. A wireless location specific information request and retrieval system, comprising:
a plurality of wireless user display device enabling the user to select a location of user's interest;
at least one server located at a remote location connected to the wireless user display device through a wireless communication network, whereby access to said server is validated by a webservice request generated by the wireless user display device;
at least one database of a location representative associated with the location of user's interest which enables the user to select a preferred location representative;
at least one location specific information database which is in communication with the remote server through a wired or the wireless communication network and transmits a location specific information to the remote server; and
at least one third party representative machine in wired or wireless communication with the remote server and with the wireless user display device,
wherein either the third party representative machine or the remote server communicates with the wireless user display device for providing a location specific information report to the user.

12. The system of claim 11, wherein said location is a location of the property, business, landmark, product, event or object.

13. The system of claim 11, wherein said location information request is an image of the property, business, landmark, product, and event or object that may contain the photo geotag for location identification.

14. The system of claim 11, wherein said location is determined by a global positioning system or the triangulated position of the user's display device.

15. The system of claim 11, wherein said selection of desired location on the wireless user display device includes location input by using a device keypad.

16. The system of claim 11, wherein said wireless user display device is a smartphone, personal digital assistance, wristphone, palmtop or laptop.

17. The system of claim 11, wherein said location information database is a third party information databases, geographic information systems (GIS), state or local agencies, local property administration and national government databases.

18. The system of claim 11, wherein said third party property representative's electronic display device is a smartphone, personal digital assistance, palmtop, laptop, desktop or other electronic display device.

19. The system of claim 11, wherein said webservice request is JSON, email, XML or HTML.

20. The system of claim 11, wherein said transmitted report is created in the JSON, email, XML or HTML.
